(19) United States
(12) Patent Application Publication
(10) Pub. No.: US 2022/0321735 A1
(43) Pub. Date: Oct. 6, 2022

(54) GRAIN PREDICTIONS

(71) Applicant: HEWLETT-PACKARD DEVELOPMENT COMPANY, L.P., Spring, TX (US)

(72) Inventors: Peter MOROVIC, Sant Cugat del Valles (ES); Jan MOROVIC, London (GB); Sergio ETCHEBEHERE JUAN, Sant Cugat del Valles (ES)

(21) Appl. No.: 17/640,235

(22) PCT Filed: Sep. 5, 2019
(86) PCT No.: PCT/US2019/049711

§ 371 Date: Mar. 3, 2022

(51) Int. Cl. H04N 1/405; H04N 1/60; H04N 1/52

(52) U.S. Cl. CPC H04N 1/4051; H04N 1/603; H04N 1/52

(57) ABSTRACT

In an example, a method includes accessing an initial prediction of a granularity metric for a halftone pattern. A correction factor to apply to the initial prediction may be determined, the correction factor being determined from a correction factor model defining a relationship between initial predictions of granularity metrics and human perceptions of granularity. The method may further include generating, using processing circuitry, a revised prediction of the granularity metric for the halftone pattern using the correction factor.

### BACKGROUND

Printing systems may convert input data (for example, data representing an image for two-dimensional printing, or data representing an object for three dimensional printing) to print instructions, which specify where print materials (for example, colorants such as inks or toners or other printable materials) are to be placed in a print operation. In some examples, printing systems may implement data transformations that convert pixels of an input image in RGB (or in any other color space) to drops of print agent (e.g., ink) on a media. The data transformation may include transformation of the input image into a format suitable for printing using drops of printing fluid, for example halftoning the input image into a pattern of dots. These transformations may be achieved in a plurality of stages, for example to generate the control data for controlling a printing device to deposit the drops of printing fluid.

### BRIEF DESCRIPTION OF DRAWINGS

Non-limiting examples will now be described with reference to the accompanying drawings, in which:

FIG. 1 is a flowchart of an example method of predicting a granularity metric;

FIG. 2 is an example halftone pattern;

FIG. 3 is a flowchart of an example method of enabling a granularity metric to be predicted;

FIG. 4 is a simplified schematic illustration of an example machine-readable medium associated with a processor;

FIGS. 5A and 5B respectively illustrate an example graph and a set of halftone patches explaining part of a procedure for generating a data set;

FIG. 6 is a simplified schematic illustration depicting an example protocol for generating a data for a model;

FIGS. 7A to 7E are graphs showing the correlation between a computed prediction and a human-perceived prediction of a grain metric based on different example models;

FIGS. 8A to 8B are graphs demonstrating the robustness of an approach for predicting grain in an example; and

FIG. 9 is a simplified schematic illustration of an example apparatus for implementing certain methods.

### DETAILED DESCRIPTION

In the case of two-dimensional printing, a print addressable location may be represented by at least one pixel, and each print addressable location may be printed with at least one colorant such as inks (for example cyan, magenta, yellow and black inks), coatings or other print materials, as well as combinations of those print materials.

In the case of three-dimensional printing, which is also referred to as additive manufacturing, three-dimensional space may be characterized in terms of ‘voxels’, i.e., three-dimensional pixels, wherein each voxel occupies or represents a discrete volume. In examples of three-dimensional printing therefore, a print addressable area may correspond to at least one voxel and each voxel may be ‘printed’ i.e., generated or manufactured, using one or a combination of agents and/or build materials.

To briefly discuss three-dimensional printing in greater detail, objects generated by an additive manufacturing process may be formed in a layer-by-layer manner. In one example, an object is generated by solidifying portions of layers of build material. In examples, the build material may be in the form of a powder or powder-like material, a fluid or a sheet material. In some examples, the intended solidification and/or physical properties may be achieved by printing an agent onto a layer of the build material. Energy may be applied to the layer and the build material on which an agent has been applied may coalesce and solidify upon cooling. In other examples, directed energy may be used to selectively cause coalescence of build material, or chemical binding agents may be used to solidify a build material. In other examples, three-dimensional objects may be generated by using extruded plastics or sprayed materials as build materials, which solidify to form an object, and/or may be colored in a post processing step.

In examples herein, possible print materials to be applied to an addressable location are specified within an element set referred to as a print agent coverage vector. In some examples, the print materials may be identified explicitly, i.e., in a set of elements comprising a set of print materials and/or print material combinations. In other examples, it may be that at least one of the elements of an element set relates to another quality, which may in turn be related to print materials. For example, an element may specify a property or the like which can be mapped to print materials. In another example, an element set may comprise a set of Neugebauer Primaries (NPs), wherein the NPs are the possible print materials and print material combinations that may be applied to a print addressable locations, along with in some examples, an amount of print material, for example the number of drops of printing agent. The NPs may be for example be associated with any or any combination of a particular print apparatus, or class of print apparatus, particular print materials, particular substrates or print media onto which print materials are to be applied, or the like.

Where a set of elements is expressed as a print agent coverage vector, each element is associated with a probability that that element will be selected for application to a print addressable element associated with the print coverage vector. The elements may each describe a print material or print material combination. The print material(s) may be described explicitly or implicitly, for example via a mapping. The elements may specify an amount of print materials (such as a colorant or coating for two dimensional printing or an agent(s). The elements may be the NPs of a given printing system. While all the NPs may be represented in a print coverage vector, some of these may be associated with a probability of 0.

For example, a print addressable location within input data (for example, a pixel in image data or a voxel in object model data) may be associated with a print agent coverage vector expressed using an element set. The element set may include elements which specify (directly or via a mapping) print materials and print material combinations which may be applied to the location, each element being associated with a probability of being applied to that location. In the case of two-dimensional printing, these may be referred to as area coverage vectors, Neugebauer Primary Area Coverage vectors (NPac vectors, or simply NPacs). In the case of three-dimensional printing, these may be referred to as volume coverage vectors, Material Volume coverage vectors (termed Mvoc vectors, or simply Mvocs, herein).

As noted above, such element sets provide a probability that a print material or a combination of print materials may be applied in a location. In a simple case, an element set may indicate that the particular print material or print material combination should be applied to a location associated with such an element set on X % of occasions, whereas (100-X)% of occasions the location should be left clear of the print material. In practice, this may be resolved at the addressable resolution for the print material and/or printing device. Therefore, if there are N addressable locations in an XY plane associated with such an element set, around X % of these N locations may be expected to receive a print material, while around (100-X)% do not.

For example, in a printing system with two available print materials (for example, inks, coatings or agents), identified as M1 and M2, where each print material may be independently deposited in an addressable area (e.g., voxel or pixel) as a single drop, there may be 2² (i.e., four) elements with associated probabilities in a given Mvoc or NPac coverage vector: a first probability for M1 without M2; a second probability for M2 without M1; a third probability for an over-deposit (i.e., a combination) of M1 and M2, e.g., M2 deposited over M1 or vice versa; and a fourth probability for an absence of both M1 and M2 (indicated as Z herein). In this example, it is assumed that a drop of print material may be applied or not: i.e., a binary choice may be made and the value for each agent may be either 0 or 1. In other words, the full set of NPs for this example printing system are M1, M2, M1M2 and Z.

In this case, a print coverage vector or element set may be: [M1:P1, M2:P2, M1M2:P3, Z:P4] or with example probabilities [M1:0.2, M2:0.2, M1M2:0.5, Z:0.1]—in a set of print addressable locations (e.g., and [x, y] or an [x, y, z] location (which in some examples may be a [x, y] location in a z slice)) to which the element set applies, and on average, 20% of locations are to receive M1 without M2, 20% are to receive M2 without M1, 50% of locations are to receive M1 and M2 and 10% are to be left clear (Z). In non-binary systems, there may be more elements defined (e.g., NPs) describing the different amounts of print agent and/or associated combinations of print agents, which may be applied. As each value is a proportion and the set of values represent the available material combinations, the set of probability values in each element set generally sum to 1 or 100%.

In some examples, as mentioned above, the elements of a vector are Neugebauer Primaries (NPs). For a binary (bi-level) printer, an NP is one of 2^{k} combinations of k print agents within the printing system, wherein inks can be represented in single-drop states, in a k-dimensional color space. For example, if a printing device uses CMY inks there can be eight NPs, these NPs relate to the following: C, M, Y, C+M overprinting (or blue), C+Y overprinting (or green), M+Y overprinting (or red), C+M+Y overprinting (or black), and W (or white or blank indicating an absence of ink). A printing device with more inks and many ink-drop states can have more NPs available than a printing device having fewer inks and having bi-level states.

In another example of a vector-ink or print agent vectors- the area/volume coverage is controlled but the ‘at pixel’ or ‘at voxel’ choices are not: i.e., the vector may specify that X % of a region receives agent M1 and Y % receives agent M2, but the overprinting of agents is not explicitly defined (although the sum of X and Y may be greater than 100, so overprinting may result). Such a vector may be termed a print agent, or ink, vector.

In summary, print agent coverage vectors may therefore specify a plurality of elements which are related to individual print agents, or explicit combinations thereof, and a probability for each element.

As referred to previously, an input image may be transformed into a format suitable for printing using drops of printing fluid by halftoning the input image into a pattern of dots, which may be referred to as a halftone pattern, halftone patch or halftone area. The manner by which the input image is halftoned (thereby selecting an element from a vector for a particular pixel/voxel) may affect how a human observer may judge the quality of the printed image. Similarly, in the case of three-dimensional printing, halftoning of object model data may affect how a human observer may judge the quality of the printed object. The following discussion is focused on the example of predicting grain or granularity of a two-dimensional printed image, but the principles described herein are also applicable to predicting grain or granularity of a three-dimensional printed object.

The level of grain or granularity in a printed image may affect the perceived quality of an image. In particular, images with a high level of granularity may be perceived to be low quality by a consumer. If the level of grain or granularity could be predicted accurately, print instructions for a printer may be determined so that an image or object can be printed with a specified level of grain or granularity, which may be useful for an end-user.

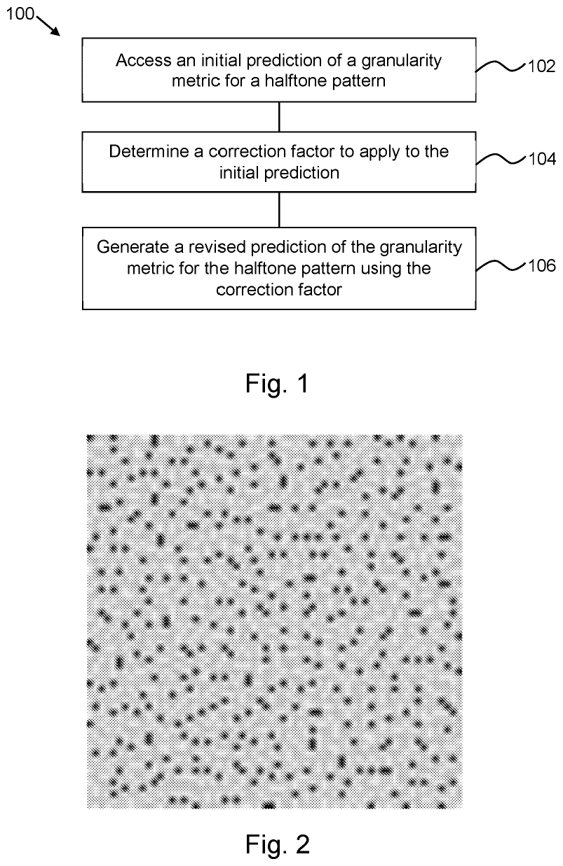

FIG. 1 depicts a flowchart of a method 100, which may be a computer-implemented method of predicting a level of grain or granularity.

The method 100 comprises, in block 102, accessing an initial prediction of a granularity metric for a halftone pattern. In some examples, the initial prediction of the granularity metric for the halftone pattern may have been generated previously, for example based on a grain prediction method. Such a method may be used to predict grain and may have a level of success in doing so. However, the predictions of such models can be inaccurate.

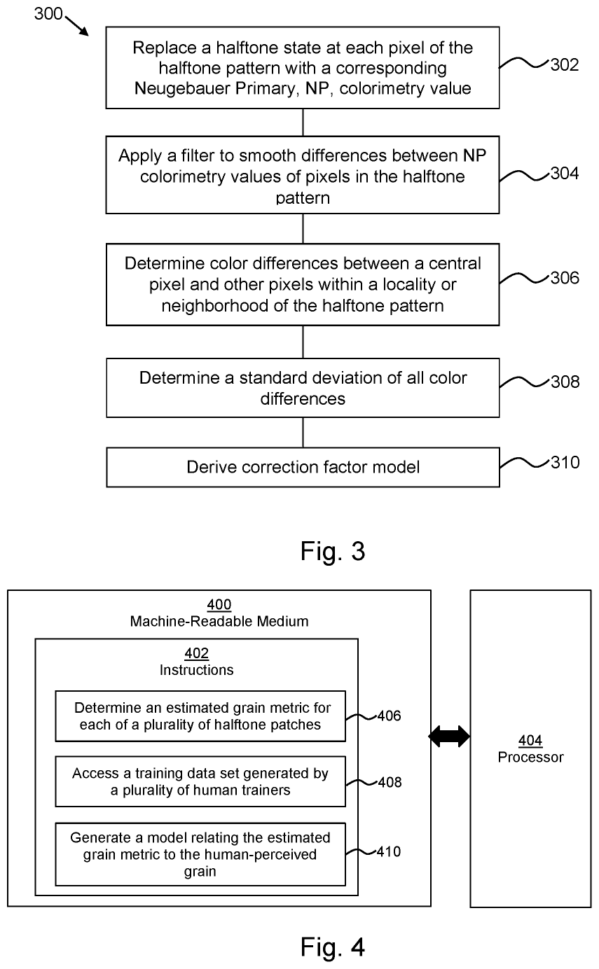

A data set comprising initial predictions of granularity metrics for each of a plurality of halftone patterns may have been previously generated. Accessing the initial prediction may comprise accessing the data set, which may be stored in a memory. In some examples, the initial prediction of the granularity metric for the halftone pattern may be generated as part of the method 100. The initial prediction(s) of the granularity metric for the halftone pattern(s) may be generated in accordance with a procedure such as described in more detail herein. One particular example of a grain prediction method which may be used to produce the initial prediction is described in greater detail with reference to FIG. 3 below.

The granularity metric may be indicative of the level of grain or granularity of a halftone pattern. The granularity metric may be a dimensionless value with a magnitude corresponding to the level of grain or granularity of the halftone pattern. The granularity metric for a halftone pattern may be used to rank the level of grain or granularity of the halftone pattern compared with other halftone patterns. For example, a lower value for the granularity metric may indicate a low level of grain (e.g., the halftone pattern may be relatively smooth, or have a high visual quality) while a higher value for the granularity metric may be indicative a high level of grain (e.g., the halftone pattern may be relatively rough, or have a relatively lower visual quality).

The method 100 further comprises, in block 104, determining, using processing circuitry, a correction factor to apply to the initial prediction. The correction factor is determined from a correction factor model defining a relationship between initial predictions of granularity metrics and human perceptions of granularity. The correction factor may be stored in a memory accessible to the processing circuitry. The correction factor model may have been determined previously based on information derived from initial predictions of granularity metrics for a plurality of halftone patterns and corresponding information derived from human trainers instructed to visually assess the plurality of halftone patterns to determine the granularity of the halftone patterns, as judged by a human trainer, to provide a psychovisual prediction.

The correction factor may be used to improve the initial prediction of the granularity metric. In this regard, the method 100 further comprises, in block 106, generating, using processing circuitry, a revised prediction of the granularity metric for the halftone pattern using the correction factor. The revised prediction may be used to update or modify print instructions for printing an image or object.

For a given application, an end-user may specify a certain level of grain or granularity for a printed image or object so that print instructions may cause the image or object to be printed with the specified level of grain or granularity. For example, a lower quality image or object may be printed if the given application is not concerned with the level of grain (e.g., a high level of grain in a large format printed media may not be concerning to an end-user if that printed media is to be observed by consumers from a large distance). On the other hand, it may be intended for printed media to have a low level of grain, for example to provide an image which will be perceived as high quality at close distances. If there is an error in the initial prediction of the granularity metric, the level of grain or granularity of a printed image or object may not be as expected. The method 100 may reduce this error such that the level of grain or granularity of a printed image or object may be closer to what level of grain or granularity is expected by an end user.

In summary therefore, examples described herein relate to a supervised machine-learning approach to predict the level of grain of a halftone pattern. The approach involves generating an initial prediction of the level of grain for a group of halftone patterns. The approach also involves improving on the initial prediction of the level of grain based on a model, therein the model may be generated using a supervised machine learning approach. In particular, human “trainers” may assess a plurality of halftone patterns to determine a trainer-perceived level of grain for the halftone patterns according to protocols designed to remove individual bias, and the model may be trained using a training data set which associates a trainer-perceived level of grain with the corresponding halftone patterns.

FIG. 2 depicts an example of a halftone pattern such as may be assessed in accordance with the method 100 of FIG. 1. The halftone pattern comprises a set of dots in two different colors that are distributed across the halftone pattern. Although the figure is shown in greyscale with two different shades of grey/black, this represents two different possible colors selected from cyan, magenta, yellow and black. Thus, an image may be constructed from a particular halftone pattern comprising a specified distribution of dots of specified colors and sizes. The perceived grain of the image may depend on the specified distribution of dots of specified colors and sizes. There may be multiple possible dot distributions that can be used to construct a halftone pattern which may be used to reproduce the same color, but the different patterns may produce different perceptible levels of grain. Therefore, the selection of dot distribution, which includes the specified colors and sizes of the dots, may influence the perceived grain or granularity of an image or object.

As has been explained previously, the approach described herein involves generating an initial prediction of the level of grain for a group of halftone patterns and then improving on the initial prediction of the level of grain based on a supervised machine learning approach. An example of this approach will now be described in more detail with reference to FIG. 3, which depicts a flowchart of an example method 300, which may be a computer-implemented method of enabling a level of grain or granularity to be predicted. At least one of the blocks of the method 300 may be performed as part of and/or in conjunction with the method 100 of FIG. 1.

The method 300 comprises generating an initial prediction of the granularity metric for a halftone pattern. In this regard, at block 302, a halftone state at each pixel of the halftone pattern is replaced with a corresponding Neugebauer Primary, NP, colorimetry value (e.g., based on Yule-Nielsen corrected CIE XYZ values), wherein the NP is selected from an print agent coverage vector, in this example an NPac, for that portion of the image based on the halftoning pattern. For example the halftone pattern may specify a threshold value for each pixel, and an NP will be selected from the NPac based on the threshold value.

At block 304, a filter is applied to smooth differences between NP colorimetry values of pixels (e.g., pixels in a locality or neighborhood) in the halftone pattern modified by block 302. For example, a convolution filter or Gaussian kernel of a specified pixel size may be applied to the halftone pattern modified by block 302. Thus, the sharp changes in color between pixels in a locality or neighborhood of the halftone pattern may be reduced.

At block 306, color differences are determined between a central pixel and other pixels within a neighborhood or locality of the halftone pattern modified by block 304. At block 308, a standard deviation of the color differences is determined across the halftone pattern (i.e., across the plurality of neighborhoods or localities of the pattern) based on the result of block 306. The standard deviation is then used to generate the initial prediction of the granularity metric for the halftone pattern.

Certain parameters may affect the initial prediction of the granularity metric. For example, the size of the halftone pattern (i.e., how big the patch under test is) and its pixel density, the size of the convolution filter or Gaussian kernel and Gaussian parameters, among others.

At block 310, the correction factor model is derived. In this example, the correction factor model is derived by minimizing a difference between the revised prediction of the granularity metric for a plurality of halftone patterns and the human perceptions of granularity of the plurality of halftone patterns. In some examples, the correction factor model may be derived by minimizing the L2-norm of the difference between the revised prediction of the granularity metric and the human perceptions of granularity. An example protocol for determining the human perceptions of granularity is described in more detail below.

In some examples, the correction factor model is determined based on the initial grain prediction for the plurality of halftone patterns. Thus, the initial grain prediction for the plurality of halftone patterns may represent an input for generating the correction factor model. In some examples, the correction factor model may be determined based on a supervised learning procedure (e.g., a regression such as a linear regression or a polynomial regression). In some examples, the regression used to develop the model may comprise an input subset of terms for polynomial regression. For example, cross-product terms (e.g., the second-order terms, or other higher-order terms) or higher-order power terms (e.g., power of two, or other higher-order powers) from a polynomial regression in isolation has been shown to provide a useful output as will be further demonstrated below. In some examples, the regression used to develop the model may comprise an input set of terms for linear regression. For example, the linear regression may be based on an input set of linear terms such as derived from the possible Neugebauer Primaries of a printing system, which has been shown to provide a useful output in an example printing system with 81 Neugebauer Primaries.

In some examples, a regularization term may be used in the regression to constrain the solution to a matrix that is considered to be robust (e.g., by constraining the rank of the matrix). In an example, the solution may be constrained by a Tikhonov regularization.

The accuracy of the correction factor model in terms of the correspondence between the predicted and human-perceived granularity metrics for the plurality of halftone patterns may depend on the selected type of element set used. For example, prediction of grain for NPacs may be more accurate than prediction of grain for print material vectors in which the ‘at pixel’ states are less well controlled. In some examples, the correction factor model may take into account the content of a vector to be used when determining print instructions (e.g., an NPac or ink vector), such as the elements thereof and any associated probabilities. In some examples, the elements of the vector may be used to determine an average print material amount for a unit area (or a given patch size) by utilizing the print material amounts and the associated coverage values/probabilities.

FIG. 4 schematically illustrates a machine-readable medium 400 (e.g., a tangible machine-readable medium) which stores instructions 402, which when executed by at least one processor 404, cause the at least one processor 404 to carry out certain example methods described herein. In some examples, the machine-readable medium 400 may be implemented in a print apparatus or a network node which may be provided in communication with a print apparatus.

The instructions 402 comprise instructions 406 to cause the at least one processor 404 to determine an estimated grain metric for each of a plurality of halftone patches. The estimated grain metric may be an example of a prediction of a granularity metric such as described in relation to FIG. 1. In an example related to the example of FIG. 3, determining the estimated grain metric comprises replacing a halftone state at each pixel with a corresponding Neugebauer Primary, NP, colorimetry value. A filter (e.g., a spatial filter) is then used to modify NP colorimetry values of the pixels to produce a modified patch. The color differences are then determined between the pixels within localities of the modified patch, and a central pixel (i.e., within each locality of the patch). A measure of deviation of any color differences across the modified patch (i.e., by collating the color differences across the different localities of the patch) is then identified (for example, the standard deviation), to estimate the grain metric for the halftone patch.

The instructions 402 comprise instructions 408 to cause the at least one processor 404 to access a training data set generated by a plurality of human trainers. The training data set comprises a ranking of the plurality of halftone patches for which the grain has been estimated in order of human-perceived grain, or human-perceived granularity, for each halftone patch as determined by the plurality of human trainers. In some examples, the set of halftone patches may include a plurality of metameric patches (i.e., have very similar colorimetry) but different levels of grain. In some examples, there may be a plurality of metameric patches for different colors.

An example protocol for generating the training data set is described in more detail below.

The instructions 402 comprise instructions 410 to cause the at least one processor to generate a model relating the estimated grain metric to the human-perceived grain. The model defines correction factors to correct estimated grain metrics. The correction factors may be used to revise the prediction of the grain or granularity metric for the halftone patches.

As mentioned previously, in some examples, a protocol may be utilized to reduce individual bias when generating the training data set. The human trainers may assess each patch more than once. In some examples, the human trainers may assess patches under controlled conditions, wherein the controlled conditions comprise any or any combination of light conditions, patch background, viewing distance, and the like. In some examples, the training data set is generated by collating each human trainer's comparison of the plurality of halftone patches to produce the ranking of the plurality of halftone patches. Thus, the human trainers may assess the plurality of halftone patches and determine the ranking based on their perception of the grain. This ranking may be input into the model so that the correction factors can be determined. An example protocol for initially generating the plurality of halftone patches to be assessed by the human trainers is described in more detail below.

In order to design a data set to be used in an experiment to allow a plurality of human trainers to pyschovisually analyze a plurality of halftone patches where those halftone patches vary in terms of the level of grain, the following example procedure was carried out.

Sources of grain can arise due to the content being printed (i.e., the halftones) or the source of grain may be related to printer behavior and stability. The procedure outlined herein focuses on designing halftone patches that sample a wide range of levels of grain due to the content being printed.

The color and image quality, IQ, of a halftone depends on the composition of the NPs as well as how these are distributed. The Halftone Area Neugebauer Separation, HANS, print control paradigm provides control for defining the overall color and IQ of a halftone. For example, this control may be selected according to: (i) which NPs are to be used (and the corresponding print materials to use), (ii) what proportions to have these NPs combine over a unit area or patch and (iii) how to spatially distribute the NPs. The control determined by the selections (i) and (ii) can be defined by an NPac vector while the control determined by the selection (iii) is determined by halftoning parameters such as dot distribution, density, etc.

The data set can be designed such that different halftone patches may, under certain conditions, approximately match in terms of overall color but differ in other aspects. Hence, halftone patches with similar colorimetries may vary in some way, for example, in terms of how they are constructed according to the selections (i), (ii) and (iii) discussed above.

Three strategies can be used to generate a metameric dataset comprising a plurality of halftone patches having approximately the same overall color but may differ in terms of e.g., which NPs are used and/or what proportions of NPs are used. A first strategy is to use an initial and partial grain optimization to find two sets of NPacs that differ significantly in terms of grain. A second strategy is to use a second order, per-NPac optimization to further tune attributes thought to affect grain. A third (final) strategy is to interpolate between the halftone patches of differing grain but matching color, to identify a halftone patch with an intermediate level of grain between two halftone patches having a different level of grain.

The example experimental test set-up was obtained by performing computations that use cyan (C), magenta (M), yellow (Y) and black (K) inks on an HP DesignJet Z3200 using glossy print media. In an example, a 4-ink system can deposit 0, 1 or 2 drops (i.e., 3 states) of each ink such that the number of possible NPs is 3⁴=81, which leads to a dimensional space of the 81 possible states.

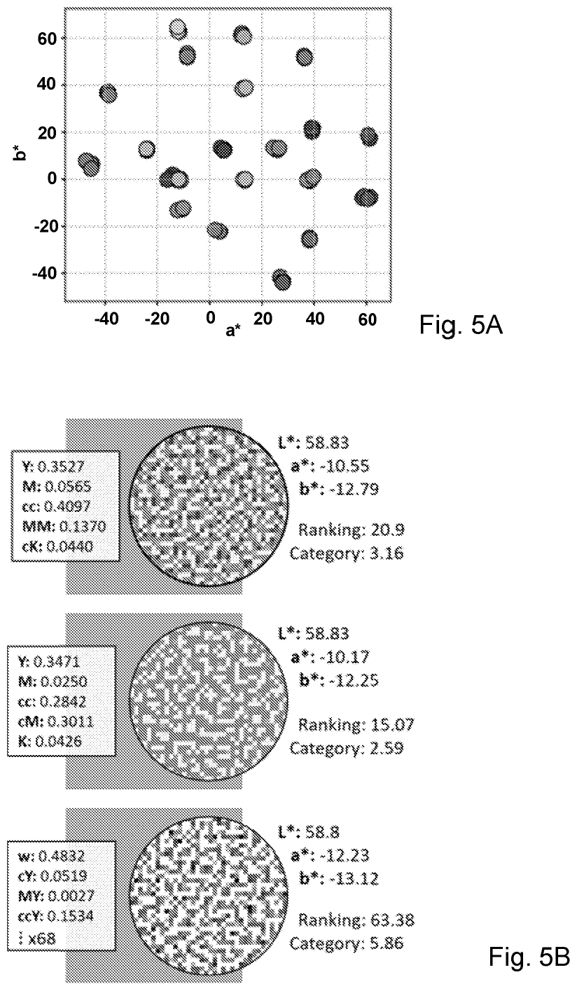

A starting point for generating the data set is based on a set of 20 sparsely distributed ‘anchor points’ in CIE L*a*b* space, for example, as depicted by the graph of FIG. 5A. For each of the colors defined in this space, an initial grain optimization was computed in which NPacs were generated using different strategies (e.g., based on tetrahedral strategies or randomly combining NPs at random coverages) that result in colorimetries close to an anchor point set, corresponding to target colors within the accessible gamut of the printing system. An example of the initial grain optimization procedure is described in Etchebehere, S., Moroviě, P., Moroviiě, J., A Psychovisual Study of Print Smoothness via Metameric Samples, in Proceedings of 27^{th} IS&T Color and Imaging Conference, October 2019, Paris (France), the content of which is hereby incorporated herein by reference in its entirety.

The estimated grain metric was also computed as described herein, i.e., by modelling a test patch (e.g., to compute the color differences over the test patch), performing a windowing or convolution operation of a specified window size to smooth color differences between the pixels and determining a measure of the deviation of the color difference between pixels and a central pixel within a neighborhood or locality of the test patch. The deviation of the (e.g., some or all) color differences over the whole test patch can then be used to estimate the grain metric. Once the NPacs, their colorimetries and grain metrics have been computed, in each neighborhood (or bin), the ‘best’ and ‘worst’ grain NPacs, according to this metric, are selected. Finally, the anchor point colorimetries are interpolated in both sets (i.e., best and worst grain sets) in order to match them such that the initial data set contains two sets of NPacs that are expected to vary in grain levels.

Intermediate patches between the two most and least grainy sets of NPacs may be computed following computation of the most and least grainy sets of NPacs. In an example, these intermediate patches are convex combinations of the two data sets that preserve colorimetry but vary in terms of level of grain.

More variety in terms of grain may be introduced (e.g., after computing the sets of NPacs) by applying a per-NPac optimization approach where a linear programming, LP, optimization is performed to compute new NPacs that use the same amounts of ink but distribute the NPs in different ways based on varying certain parameters. For example, the parameters could be varied in the following ways: controlling the amount of white coverage, promoting inks placed side-by-side such as C, M, C+C (i.e., two drops of cyan) inks printed side-by-side, or attempting to overprint different ink colors such as C+M, C+Y, C+C+M on top of each other. These LP-based approaches may act as proxies to the intuition of grain being related to the local contrast of NPs within a halftone patch such that a halftone patch containing white (i.e., blank print media) would be considered to be grainier, while halftone patches that use NPs whose colorimetries are closer to each other tend to be perceived to be less grainy.

Finally, in this example procedure, all NPacs are halftoned using a parallel random area weighted coverage selection, PARAWACS, halftoning algorithm, where a single halftone matrix determines the spatial distribution of the NPacs. Different halftone matrices can be used as a spatial selector to determine where each NP is to be positioned within a halftone patch. Thus, the halftone matrix determines the pattern of the halftone and may be considered to be closely related to the grain. In an example, the halftone matrices are based on: a default blue-noise matrix that tends to produce a low grain for certain NPacs, a relatively more-clustered green-noise matrix that tends to produce grainier prints compared with the blue-noise matrix and a control set using a white noise matrix that tends to produce very grainy prints regardless of the choice of NPac.

The above procedure may generate many different metameric halftone patches based on different NPacs for a given colorimetry. In order to reduce the number of samples, a selection was made by eye such that any barely distinguishable halftone patches (i.e., barely distinguishable in terms of color and grain) were removed from the data set so that each halftone patch is sufficiently different from all others.

At the end of this example procedure, a data set containing eighty halftone patches was obtained. The halftone patches were based on colorimetry values centered around the 20 different locations in CIE L*a*b* space depicted by FIG. 5A (wherein the colorimetry is indicated as a circle) a such that each of these locations had between 3 and 5 patches differing in terms of grain. The colorimetric difference between the halftone patches considered to have the same color were on the average of 0.61 CIE ΔE 2000, with the 95^{th} percentile of 1.65 for CIE illuminant D50. Thus, the halftone patches considered to have the same color are those which cannot be distinguished from each other by eye if placed close to each other on a grey background. By contrast, a colorimetric difference of 1 ΔE 2000 corresponds to a ‘just noticeable difference’ under the same conditions and a colorimetric difference of 1.65 ΔE 2000 would still mean that it would be difficult for an observer to distinguish between the halftone patches.

This means that the data set provides a set of twenty different printed colors, with each of these colors being associated with a set of near-metameric halftone patches which closely match in terms of color but vary in terms of the grain. While a particular set of colorants and a printing system have been discussed herein, such a set of test patches could be generated by other colorant sets/systems and/or the number of colors and metamers of each color may differ in other examples.

Other example procedures may be used to generate the data set. In some examples, a set of test patches with different levels of grain could be generated based on a CMYK-interfaced system. For example, the CMYK-interfaced system could generate the test patches with a variety of grains by varying the amount of ‘K’ compared with the amount of ‘C+M+Y’ where a high amount of ‘K’ provides a grainier patch compared with relatively low amounts of ‘K’. Although such a system generates test patches with a variety of grain, other image parameters such as halftoning, halftone structure and NP composition may not change apart from the amount of ‘K’ present in the test patches. In some examples, a set of test patches with different levels of grain could be generated by varying the halftoning within a set of test patches (e.g., different halftone matrices could be used to provide different levels of grain across the set).

FIG. 5B shows an example of three different metameric halftone patches (i.e., the patches have a very similar in color) that have a significantly different NPac structure as shown by the expanded view of each halftone patch. The top halftone patch is constructed with non-overlapping inks with mainly NPs of Y, C and M being arranged side-by-side. The middle halftone patch is constructed by overprinting of C+M, which results in a lower contrast of the NPs within the patch and hence, reduced perceived grain compared with the top halftone patch. The bottom halftone patch is constructed using 68 different NPs and has a white (blank) area coverage of almost 50% of the halftone patch area, to provide a high contrast with the white and hence, an increased perceived grain compared with the top and middle halftone patches. As can be recognized from the numerical values accompanying the top, middle and bottom halftone patches of FIG. 5B for the ranking and category, the middle halftone patch is considered to be the least grainy according to the initial prediction, the top halftone patch is more grainy than the middle halftone patch and the bottom halftone patch is the most grainy of the three halftone patches.

An experiment was set up to allow a plurality of human trainers to pyschovisually analyze a plurality of halftone patches generated using the procedure outlined above in relation to FIG. 5A. As will be described in more detail below, eighty halftone patches were provided to be assessed by the plurality of trainers. These eighty halftone patches were defined by the process described above and were halftoned at 1200 dots per inch, dpi, to result in patches of 1 inch (2.54 cm) square which were cut to show no blank substrate around the edges of the halftone patch.

During the experiment, the halftone patches were placed on a neutral gray surface, under controlled lighting conditions (in the example, using a CIE illuminant D50 simulator in a VeriVide viewing booth). The human trainers were presented with the patches at a fixed starting distance, in this example a starting distance of approximately 50 cm viewing distance, meaning that the halftone patch occupied approximately 3° of visual angle. The human trainers were free to inspect the halftone patches from closer-up. The human trainers did not have any other visual cues in the environment except for a white patch of blank substrate that was used to facilitate adaptation to the viewing environment. While such standardized conditions may not be provided in all examples, such factors may, alone or in any combination, assist in increasing the consistency of the assessment.

A total of twenty human trainers participated in the experiment. Fifteen of the trainers were considered as experts at evaluating printing attributes and artifacts. Examples of the experts included engineers and scientists who routinely perform visual image quality, IQ, evaluations. The remaining five trainers were considered non-experts. All human trainers exhibited normal color vision when tested with Ishihara's colorblindness test and had normal or corrected-to-normal visual acuity. Although a difference was observed between the performance of the experts and non-experts since there was a greater consistency in terms of the selections made by the experts, this was not considered to be significant difference from a statistical point of view, and therefore in other examples, the proportion of experts to non-experts may not be taken into account.

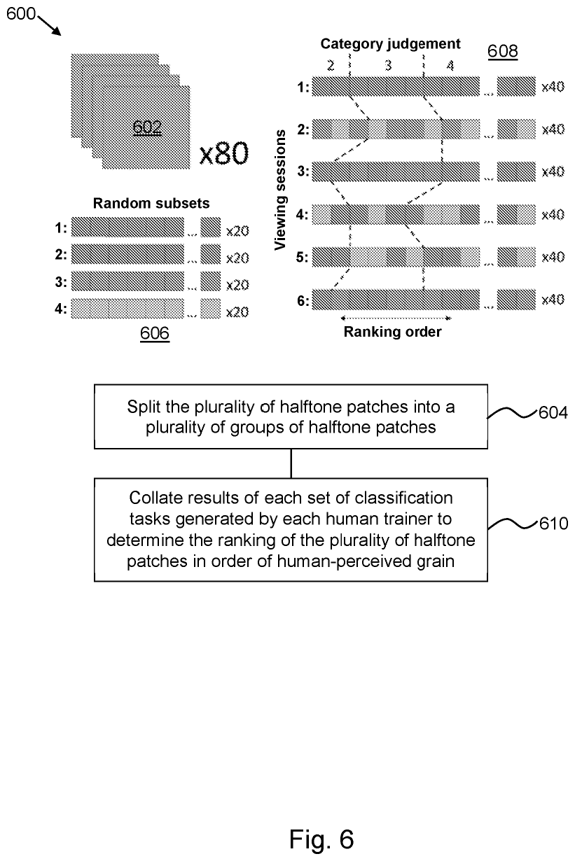

In an example protocol 600 depicted by FIG. 6, human trainers are given a task to compare a plurality of halftone patches 602 to generate information for the training data set. This information is generated by, at block 604, splitting the plurality of halftone patches 602 into a plurality of groups 606 of halftone patches 602.

In the experimental run of the protocol 600, also depicted by FIG. 6, the set of halftone patches were randomly split into groups, in this example four groups of twenty halftone patches 602. Each human trainer was asked to perform a classification task six times, with two groups 606 of the halftone patches 602 being assessed by the human trainer in each viewing session. In other words, forty halftone patches 602 were assessed by each human trainer in each viewing session. There were six possible group combinations 608 of the four groups and each human trainer classified each halftone patch 602 three times over the six viewing sessions.

At block 610, the protocol 600 comprises collating results of each set of classification tasks generated by each human trainer to determine the ranking of the plurality of halftone patches 602 in order of human-perceived grain. Each human trainer was directed to perform a set of classification tasks to rank the plurality of halftone patches 602 in order of human-perceived grain. Each classification task comprises classifying different combinations of the groups 606 of halftone patches 602 selected from the plurality of groups 606 such that each human trainer evaluates every permutation of the different combinations of the groups 606 of halftone patches 602.

For example, collating the results at block 610 may comprise at least one of: task (i) collating halftone patches 602 of a selected combination of groups 606 of halftone patches 602 which are sorted from least to most grainy by a human trainer; and task (ii) rank each halftone patch 602 according to a grain category selected from a plurality of grain categories indicative of a relative level of grain. In the experimental run of the protocol 500 described above, both of these classification types (i) and (ii) were performed by the human trainers in the following manner to allow an evaluation as to whether that the plurality of human trainers have objectively assessed the plurality of halftone patches 602

For task type (i), each human trainer was asked to sort all halftone patches 602 from least to most grainy, with the possibility of judging two or more halftone patches 602 as equally grainy. For task type (ii), each human trainer was asked to rank each halftone patch 602 into a grain category extending between a grain value of one for no grain to seven for most grain. An anchor halftone patch with no grain (i.e., 100% coverage of a single ink) was provided for each viewing session to assist the human trainers with making the comparison. While this need not be the case in all examples, the viewing sessions were divided over time, to reduce fatigue. In this particular example, the six viewing sessions were split over two days (three sessions per day) and a five minute break was taken in-between the viewing sessions on the same day. In total, for twenty human observers over the six viewing sessions of the various permutations of the four groups 606, 20×6×40=4800 grain judgements were made.

As mentioned above, the protocol 600 comprises collating results of each set of classification tasks generated by each human trainer to determine the ranking of the plurality of halftone patches 602 in order of human-perceived grain. In this example, the ranking of the plurality of halftone patches 602 is determined according to:

$$Ranking = \frac{{\sum }_{i = 1}^{N} {S}_{i}}{N} + {\sum }_{i = 1}^{N} {D}_{i} \qquad ( 1 )$$

where Sᵢ is a relative order of a specified halftone patch 602 within the halftone patches 602 of a specified group 606 in an i-th viewing session, Dᵢ is an order of the specified halftone patch 602 relative to all of the other halftone patches 602 and N is the number of viewing sessions in which each trainer has viewed each group 606 of halftone patches 602.

Providing the two types (i) and (ii) of classification tasks may allow additional insights to be gained regarding how the human trainers perceive the halftone patches 606 in terms of the level of grain, which may improve the accuracy of the model (e.g., a correction factor model). For example, judging the grain category provides an absolute value that relates directly to a human-perceived grain, while the ranking order provides a degree of discrimination between the different halftone patches 602. For the experimental run, a high degree of consistency was observed between the responses to the classification tasks such that the Pearson correlation coefficients between three different scores (i.e., the ranking of task (i), the category judgement of task (ii) and the combination of tasks (i) and (ii)) were found to be greater than 0.99. Therefore, either task may be used alone or in combination in other examples.

Providing multiple trainers, each assessing overlapping data sets, may reduce individual bias in the training data set. Providing the opportunity for each trainer to assess a halftone patch multiple times may allow inconsistencies to be identified and, if needed, such data may be excluded from the data sets. However, these features may not be implemented in all examples.

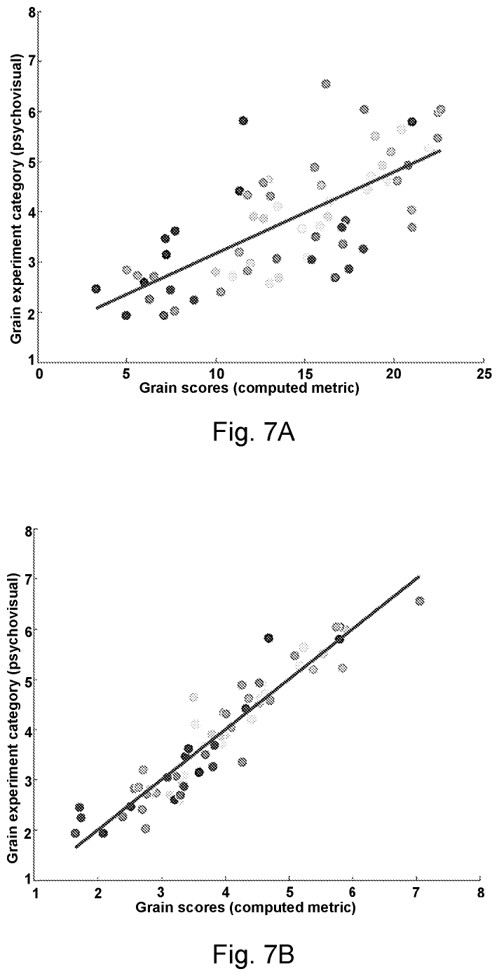

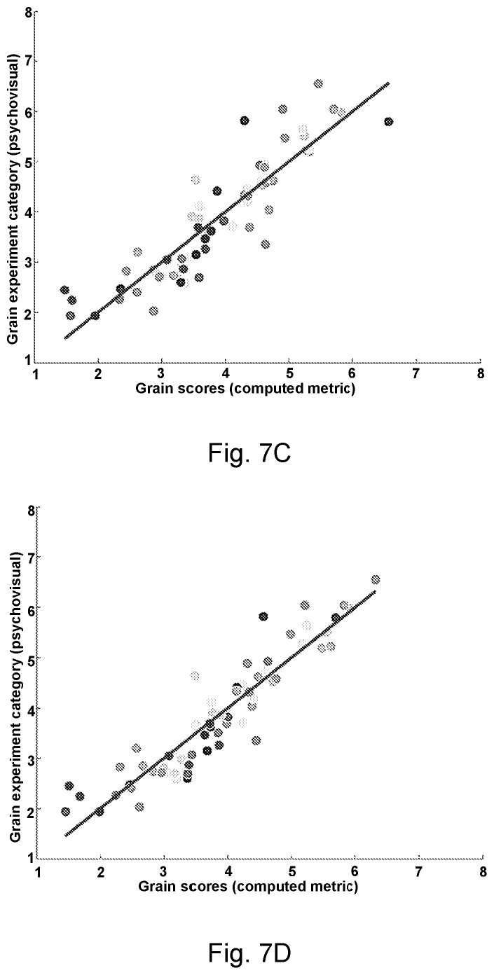

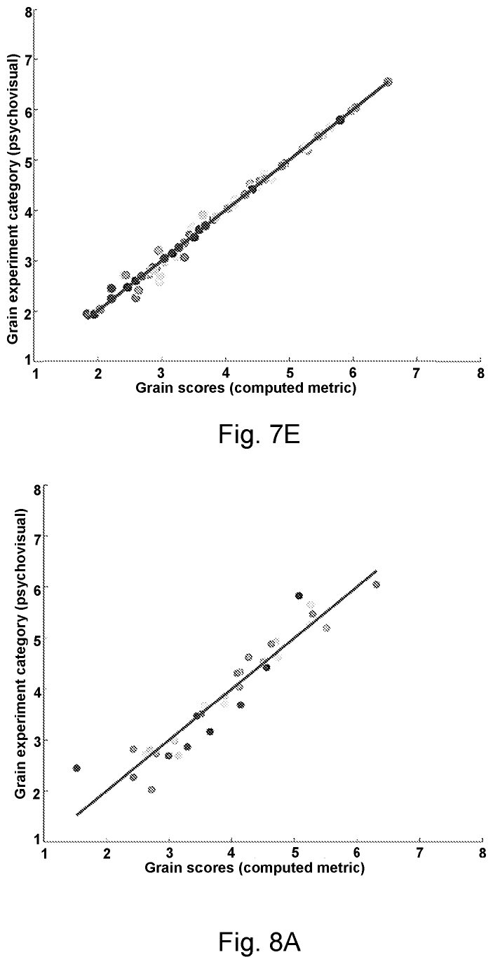

In some examples, the model is based on a set or subset of terms selected for a regression model (e.g., a linear regression model or a polynomial regression model). FIGS. 7A to 7E are graphs showing the correlation between different grain predictions according to which terms were used as an input for a regression model and which print agent coverage vector type is used. The x-axis on the graphs represents the computed grain metric score (e.g., grain value) for either the initially estimated grain metric or the revised grain metric. The y-axis on the graphs represents the human-perceived grain metric.

FIG. 7A depicts the correlation between the initial prediction of the grain metric (e.g., according to block 102 of FIG. 1 or the estimated grain metric according to block 406 of FIG. 4) and the human-perceived grain metric. For FIG. 7A, a Pearson correlation coefficient, R=0.719 and an R-squared value of 0.517 was obtained.

FIGS. 7B to 7E depict examples of the correlation between the revised prediction of the grain metric (e.g., according to block 106 of FIG. 1) and the human-perceived grain metric based on different input terms for a regression model and different types of print agent coverage vectors. In each depicted example, an improvement in the correlation between the revised prediction of the grain metric and the human-perceived grain metric was observed compared with the example of FIG. 7A.

In FIG. 7B, a full expansion of a second-order polynomial regression based on a 4-ink set-up was used to model the relationship between the revised prediction of the grain metric and the human-perceived grain metric when representing the patches using print agent vectors which specified ink-amounts but did not explicitly control ink-combination coverages. In this example, an R-value of 0.941 and an R-squared value 0.886 was obtained. The 4-ink set-up used in this example is a CMYK-based system in which the previous grain prediction plus the full expansion of the second-order polynomial regression provides 15 terms for the model as follows: [Grain C M Y K CM CY CK MY MK YK C² M² Y² K²] where the first term ‘Grain’ is the previous grain prediction, the next four terms are the linear ink terms, the next six terms are the cross-product ink terms and the final four terms are the second-order ink terms.

In FIG. 7C, the cross-products of the second-order polynomial regression based on a 4-ink set-up were used to model the relationship between the revised prediction of the grain metric and the human-perceived grain metric when representing the patches using print agent vectors which specified ink-amounts but did not explicitly control ink-combination coverages. In this example, an R-value of 0.899 and an R-squared value 0.809 was obtained. The 4-ink set-up used in this example is a CMYK-based system in which the previous grain prediction plus the cross-products of the second-order polynomial regression provides 11 terms for the model as follows: [Grain C M Y K CM CY CK MY MK YK].

In FIG. 7D, the second-order powers of the second-order polynomial regression based on a 4-ink set-up were used to model the relationship between the revised prediction of the grain metric and the human-perceived grain metric when representing the patches using print agent vectors which specified ink-amounts but did not explicitly control ink-combination coverages. In this example, an R-value of 0.928 and an R-squared value 0.861 was obtained. The 4-ink set-up used in this example is a CMYK-based system in which the previous grain prediction plus the second-order powers of the second-order polynomial regression provides 9 terms for the model as follows: [Grain C M Y K C² M² Y² K²].

In FIG. 7E, in an NPac vector-based approach, linear components based on the 81 possible Neugebauer Primaries plus the previous grain prediction (i.e., 82 terms in total) were used to model the relationship between the revised prediction of the grain metric and the human-perceived grain metric when representing the patches using NPac vectors which specified coverages and which do explicitly control all ink-combinations such as overprinting. In this example, an R-value of 0.994 and an R-squared value 0.989 was obtained.

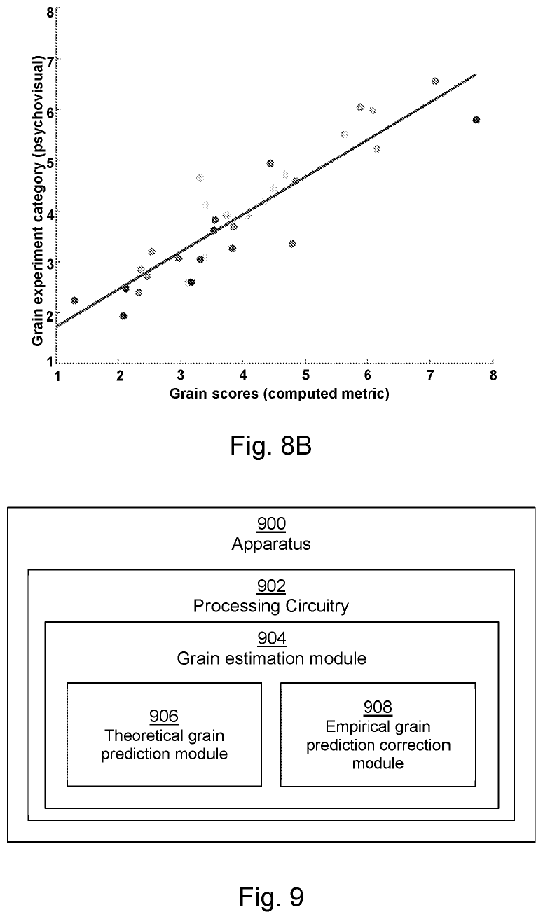

As can be seen from FIGS. 7B to 7E, the correlation between the revised prediction of the grain metric and the human-perceived grain metric is substantially improved compared with simply using the initial prediction of the grain metric. While the NPac-based approach with linear terms demonstrates a high level of performance in terms of the correlation, this may be considered to be the result of overfitting since the relationship is based on a system with 81 NPs and one additional term for the initial (previous) grain prediction (i.e., 82 terms in total). In this example, the data set was trained based on 66 data points. FIGS. 8A and 8B demonstrates the robustness of the approach by training and testing on different parts of the available data of 66 data points. In this example, the set of data points were split into two equally sized sets of 33 data points. The first set was used to train the model, as shown by FIG. 8A and the second set was used to test the model, as shown by FIG. 8B. An R-value of 0.953 and an R-squared value of 0.907 was obtained for the correlation between the revised prediction of the grain metric and the human-perceived grain metric of the training set of FIG. 8A. An R-value of 0.917 and an R-squared value of 0.840 was obtained for the correlation between the revised prediction of the grain metric and the human-perceived grain metric of the testing set of FIG. 8B. As can be seen from a comparison of FIGS. 8A and 8B, the approach described herein for generating the model relating the estimated grain metric to the human-perceived grain may be considered to be relatively robust.

The approach described above may provide accuracy gains in terms of grain prediction as compared with the initial prediction of the grain metric. Further, a finer level of distinction may be made between different grain levels. The approaches described herein may: provide improved results in terms of better color separations, improved optimization for printing and/or the ability to co-optimize visual IQ with other metrics (e.g., if the grain of a halftone pattern can be estimated with a high degree of accuracy, it may be possible to ‘mine’ a large number of NPacs to identify those NPacs that are best in terms of IQ and have other optimal attributes without resorting to performing printing and visually inspecting the prints, which may be infeasible for such a large number of NPacs). The computation may be considered to be relatively simple so that the evaluation can be performed rapidly, which may provide the potential for an end-user to implement certain methods described herein.

FIG. 9 is a schematic illustration of apparatus 900 for implementing certain methods described herein. The apparatus 900 may provide the revised prediction of the granularity metric, for example, as described in relation to the method 100 of FIG. 1. The apparatus 900 comprises processing circuitry 902. The processing circuitry 902 comprises a grain estimation module 904 to estimate a grain parameter (e.g., a granularity metric or grain metric) for a halftone area (e.g., a halftone pattern or halftone patch). The grain estimation module 904 comprises a theoretical grain prediction module 906 and an empirical grain prediction correction module 908. In use, the theoretical grain prediction module 906 may implement certain methods described herein which, for example, provide an initial prediction of the granularity metric or estimate the grain metric. In this example, the theoretical grain prediction module 906 determines: colorimetry values of pixels in the halftone area; applies a smoothing spatial filter to the halftone area; and determines a theoretical grain metric prediction by determining color differences between a central pixel and other pixels within a locality of the central pixel following smoothing. In use, the empirical grain prediction correction module 908 may implement certain methods described herein which, for example, obtain a revised prediction of the granularity metric. In this example, the empirical grain prediction module 908 corrects the theoretical grain metric prediction based on a predetermined relationship between human-perceived grain levels and theoretical grain metric predictions. The predetermined relationship may be based on a correction factor model or other model which corrects for any inaccuracies between the initial or theoretical grain prediction and the human-perceived grain.

In some examples, the predetermined relationship may be determined by a regression to minimize an L2-norm of a difference between the theoretical grain metric predictions for a plurality of halftone areas and the human-perceived grain levels for the plurality of halftone areas.

In some examples, the predetermined relationship may be determined based on terms used as an input for a linear regression or polynomial regression.

The processing circuitry 902 may for example carry out blocks of the methods described above and/or execute the instructions stored on the machine readable medium 400.

Examples in the present disclosure can be provided as methods, systems or as a combination of machine readable instructions and processing circuitry. Such machine readable instructions may be included on a non-transitory machine (for example, computer) readable storage medium (including but not limited to disc storage, CD-ROM, optical storage, etc.) having computer readable program codes therein or thereon.

The present disclosure is described with reference to flow charts and block diagrams of the method, devices and systems according to examples of the present disclosure. Although the flow charts described above show a specific order of execution, the order of execution may differ from that which is depicted. Blocks described in relation to one flow chart may be combined with those of another flow chart. It shall be understood that each block in the flow charts and/or block diagrams, as well as combinations of the blocks in the flow charts and/or block diagrams can be realized by machine readable instructions.

The machine readable instructions may, for example, be executed by a general purpose computer, a special purpose computer, an embedded processor or processors of other programmable data processing devices to realize the functions described in the description and diagrams. In particular, a processor or processing circuitry, or a module thereof, may execute the machine readable instructions. Thus functional modules of the apparatus 900 (for example, the grain estimation module 904, the theoretical grain prediction module 906 and/or the empirical grain prediction correction module 908) and devices may be implemented by a processor executing machine readable instructions stored in a memory, or a processor operating in accordance with instructions embedded in logic circuitry. The term ‘processor’ is to be interpreted broadly to include a CPU, processing unit, ASIC, logic unit, or programmable gate array etc. The methods and functional modules may all be performed by a single processor or divided amongst several processors.

Such machine readable instructions may also be stored in a computer readable storage that can guide the computer or other programmable data processing devices to operate in a specific mode.

Such machine readable instructions may also be loaded onto a computer or other programmable data processing devices, so that the computer or other programmable data processing devices perform a series of operations to produce computer-implemented processing, thus the instructions executed on the computer or other programmable devices realize functions specified by block(s) in the flow charts and/or in the block diagrams.

Further, the teachings herein may be implemented in the form of a computer program product, the computer program product being stored in a storage medium and comprising a plurality of instructions for making a computer device implement the methods recited in the examples of the present disclosure.

While the method, apparatus and related aspects have been described with reference to certain examples, various modifications, changes, omissions, and substitutions can be made without departing from the spirit of the present disclosure. It is intended, therefore, that the method, apparatus and related aspects be limited by the scope of the following claims and their equivalents. It should be noted that the above-mentioned examples illustrate rather than limit what is described herein, and that many implementations may be designed without departing from the scope of the appended claims. Features described in relation to one example may be combined with features of another example.

The word “comprising” does not exclude the presence of elements other than those listed in a claim, “a” or “an” does not exclude a plurality, and a single processor or other unit may fulfil the functions of several units recited in the claims.

The features of any dependent claim may be combined with the features of any of the independent claims or other dependent claims.

1. A method comprising:
accessing an initial prediction of a granularity metric for a halftone pattern;
determining, using processing circuitry, a correction factor to apply to the initial prediction, the correction factor being determined from a correction factor model defining a relationship between initial predictions of granularity metrics and human perceptions of granularity; and
generating, using processing circuitry, a revised prediction of the granularity metric for the halftone pattern using the correction factor.

2. The method of claim 1, where the correction factor model is derived by minimizing a difference between the revised prediction of the granularity metric for a plurality of halftone patterns and the human perceptions of granularity of the plurality of halftone patterns.

3. The method of claim 1, where the correction factor model is determined based on a regression.

4. The method of claim 3, where the regression is based on an input set or subset of terms comprising one of: linear terms of a linear regression; cross-product terms of a polynomial regression; and higher-order power terms of a polynomial regression.

5. The method of claim 1, comprising generating the initial prediction of the granularity metric for the halftone pattern is generated by:
replacing a halftone state at each pixel with a corresponding Neugebauer Primary, NP, colorimetry value;
applying a filter to smooth differences between NP colorimetry values of pixels in the halftone pattern;
determining color differences between a central pixel and other pixels within a locality of the halftone pattern; and
determining a standard deviation of the color differences across the halftone pattern, where the standard deviation is used to generate the initial prediction of the granularity metric for the halftone pattern.

6. A tangible machine-readable medium storing instructions which, when executed by at least one processor, cause the at least one processor to:
determine an estimated grain metric for each of a plurality of halftone patches;
access a training data set generated by a plurality of human trainers, the training data set comprising a ranking of the plurality of halftone patches in order of human-perceived grain for each halftone patch as determined by the plurality of human trainers; and
generate a model relating the estimated grain metric to the human-perceived grain, where the model defines correction factors to correct estimated grain metrics.

7. The tangible machine-readable medium of claim 6, where the training data set is generated by collating each human trainer's comparison of the plurality of halftone patches to produce the ranking of the plurality of halftone patches.

8. The tangible machine-readable medium of claim 6, where the training data set is generated by:
splitting the plurality of halftone patches into a plurality of groups of halftone patches; and
collating results of each set of classification tasks generated by each human trainer to determine the ranking of the plurality of halftone patches in order of human-perceived grain, where each human trainer was directed to perform a set of classification tasks to rank the plurality of halftone patches in order of human-perceived grain, where each classification task comprises classifying different combinations of the groups of halftone patches selected from the plurality of groups such that each human trainer evaluates every permutation of the different combinations of the groups of halftone patches.

9. The tangible machine-readable medium of claim 8, where collating the results comprises collating halftone patches of a selected combination of groups of halftone patches which are sorted from least to most grainy by a human trainer; and
ranking each halftone patch according to a grain category selected from a plurality of grain categories indicative of a relative level of grain.

10. The tangible machine-readable medium of claim 9, where the ranking of the plurality of halftone patches is determined according to:
$$Ranking = \frac{{\sum }_{i = 1}^{N} {S}_{i}}{N} + {\sum }_{i = 1}^{N} {D}_{i}$$
where Sᵢ is a relative order of a specified halftone patch within the halftone patches of a specified group in an i-th viewing session, Dᵢ is an order of the specified halftone patch relative to all of the other halftone patches and N is the number of viewing sessions in which each trainer has viewed each group of halftone patches.

11. The tangible machine-readable medium of claim 6, where the model is based on a set or subset of terms selected for a regression model.

12. The tangible machine-readable medium of claim 6, where the instructions cause the at least one processor to estimate the grain metric for each of the plurality of halftone patches by, for each halftone patch:
replacing a halftone state at each pixel with a corresponding Neugebauer Primary, NP, colorimetry value;
using a filter to modify NP colorimetry values of the pixels to produce a modified patch;
determining color differences between the pixels within localities of the modified patch; and
identifying a deviation of any color differences across the modified patch, to estimate the grain metric for the halftone patch.

13. Apparatus comprising:
a grain estimation module to estimate a grain parameter for a halftone area, the grain estimation module comprising:
a theoretical grain prediction module and an empirical grain prediction correction module, where:
the theoretical grain prediction module is to:
determine colorimetry values of pixels in the halftone area;
apply a smoothing spatial filter to the halftone area;
and determine a theoretical grain metric prediction by determining color differences between a central pixel and other pixels within a locality of the central pixel following smoothing; and
the empirical grain prediction correction module is to:
correct the theoretical grain metric prediction based on a predetermined relationship between human-perceived grain levels and theoretical grain metric predictions.

14. The apparatus of claim 13, where the predetermined relationship is determined by a regression to minimize an L2-norm of a difference between the theoretical grain metric predictions for a plurality of halftone areas and the human-perceived grain levels for the plurality of halftone areas.

15. The apparatus of claim 13, where the predetermined relationship is determined based on terms used as an input for a linear regression or polynomial regression.
